(19) United States
(12) Patent Application Publication
(10) Pub. No.: US 2008/0197093 A1
(43) Pub. Date: Aug. 21, 2008

(54) TRUSS HANDLING APPARATUS

(76) Inventors: Timothy K. McAdoo, Euless, TX (US); David L. McAdoo, Alvarado, TX (US); Danny Lee Rupe, Colleyville, TX (US)

Correspondence Address: CRUTSINGER & BOOTH, 1601 ELM STREET, SUITE 1950, DALLAS, TX, 752014744, US

(21) Appl. No.: 11/676,060

(22) Filed: Feb. 16, 2007

(51) Int. Cl. B66C 1/42

(52) U.S. Cl. 212/257

(57) ABSTRACT

An apparatus and method for handling completed trusses. The truss handling apparatus moves completed trusses from a conveyor system to selected stacks in a staging area. The truss handler has an extendable boom crane mounted for rotational movement. The crane includes a truss engaging assembly which engages a completed truss such that it can be lifted by the boom crane. The engagement assembly rotates and tilts the engaged truss such that it can be aligned with a stack of trusses. The truss engaging assembly has movable arms to engage trusses of varying size and shape and has hooks for grappling the truss. The apparatus can stack the completed trusses in any of multiple stacks in a staging area. The trusses in each stack can be oriented horizontally, vertically or otherwise.

### TECHNICAL FIELD

The present invention relates generally to the field of building construction and more particularly, to the production of wooden trusses and the handling and stacking of completed trusses.

### BACKGROUND

Roof and floor trusses are typically assembled on a horizontal jigging table of sufficient size to accommodate an entire truss assembly, which typically ranges fourteen feet by 60, 80, or 100 feet or more. Such truss assemblies are designed to span the width of a structure, such as a house, and are made using two-by-four, six, eight or other suitable wooden members, joined at intersections by nail plates. Trusses can also be made from light gage formed steel using screws for fastening at the joints. The trusses lie flat on the elongated table during assembly. Since the trusses have little flexural strength in this plane, they must be supported at intervals for lifting from the table after completion. The completed trusses are then typically transported via conveyor, typically having rollers, to a further pressing operation and then to a staging area away from the truss assembly table. The completed trusses are then stacked in the staging area for later access or transport to a construction site. The stacking and arrangement of the trusses is often completed by hand. Alternately, a material handler or truss handling device either stacks the completed trusses horizontally or tilts them vertically to be stacked. The stacked trusses are often strapped together in appropriate numbers for shipment.

Prior art automatic truss handling devices have limitations. Typical prior art devices stack trusses as they are received on a conveyor system. The devices either stack the trusses horizontally or vertically. These devices place the trusses in stacks, aligning the trusses against indexing posts or rails. While this is adequate for trusses of similar size and shape, it creates problems where the trusses are dissimilar. For transport, the trusses are placed in stacks and then strapped together. For stability, the trusses are arranged such that underlying truss members (chords and webs) provide as much support as possible for the members of overlying trusses. Adequately aligning dissimilar trusses may be difficult or impossible using prior art material handlers since all of the trusses in a given stack are aligned utilizing the same indexing posts or rails. Where, for example, two trusses of differing slopes, heights and lengths are stacked adjacent one another using an indexing guide, they may “overlap” or be coextensive only minimally. Binding or strapping such a stack together with adequate support for the overlying trusses may require excessive shoring-up of the overlying trusses.

Computer aided design systems have facilitated the design of more complex roof configurations and these have become increasingly popular with builders. Thus, building structures often incorporate a number of different truss designs. As a result, it is desirable to have the ability to manage a number of different sizes and types of trusses in process simultaneously. Staging and handling a variety of truss shapes and sizes concurrently can create inefficiencies.

There is a need for an apparatus and method for efficiently handling completed trusses without modification or damage to the truss product or the existing truss production equipment.

### SUMMARY OF THE INVENTION

A truss handling apparatus and method are presented for arranging completed trusses in multiple stacks in a staging area. A preferred embodiment utilizes a deck supporting an extendable boom crane, the boom crane mounted for rotational movement in relation to the deck. The deck may be supported on a movable frame having, for example, wheels designed to run on tracks mounted on the ground. At the working end of the boom crane is mounted a truss engaging assembly which is able to engage a truss such that it may be lifted using the boom crane. Preferably, the truss engaging assembly is able to both rotate and tilt the engaged truss. The truss handling apparatus lifts the truss, moves the truss to a selected stack of trusses, rotates the truss such that it aligns with other trusses in the stack and then places the truss in the stack. The rotation of the boom crane and movement of the truss engaging assembly allow for efficient arrangement of the multiple stacks of trusses and alignment of trusses in a stack.

In this manner, a greater variety of truss shapes and sizes may be efficiently handled concurrently.

### BRIEF DESCRIPTION OF THE DRAWINGS

The accompanying drawings are incorporated into the specification to assist in explaining the present invention. The drawings illustrate preferred and alternative examples of how the invention can be made and used and are not to be construed as limiting the invention to only those examples illustrated and described. The various advantages and features of the present invention will be apparent from a consideration of the drawings in which:

FIG. 1 is a plan view showing an exemplary truss stacking arrangement, the trusses oriented both horizontally and vertically, according to the method and apparatus of the present invention;

FIG. 2A is an exploded orthogonal view of a stack of trusses of dissimilar shape and size;

FIG. 2B is a top and front elevation view of the stack of trusses of dissimilar size and shape of FIG. 2A;

FIG. 3 is an elevation view of an embodiment of the boom crane for use in the present invention;

FIG. 4 is an orthogonal view of the truss engagement assembly of the device for handling a truss;

FIG. 5 is a detail view of the truss engagement assembly, showing the truss contacting assembly in an open position; and

FIG. 6 is a detail view of the truss engagement assembly, showing the truss contacting assembly in an closed position.

### DETAILED DESCRIPTION OF THE DRAWINGS

The present invention is described in the following by referring to drawings of examples of how the invention can be made and used. In these drawings, reference characters are used throughout the views to indicate corresponding parts. The embodiments shown and described herein are exemplary. Many details are well known in the art or will be apparent to those skilled in the art, and as such may be neither shown nor described. The present invention relates to or employs some steps and apparatus well known in the mechanical arts and such are not the subject of detailed discussion herein. These inventions teach a method of handling a number of different type trusses concurrently.

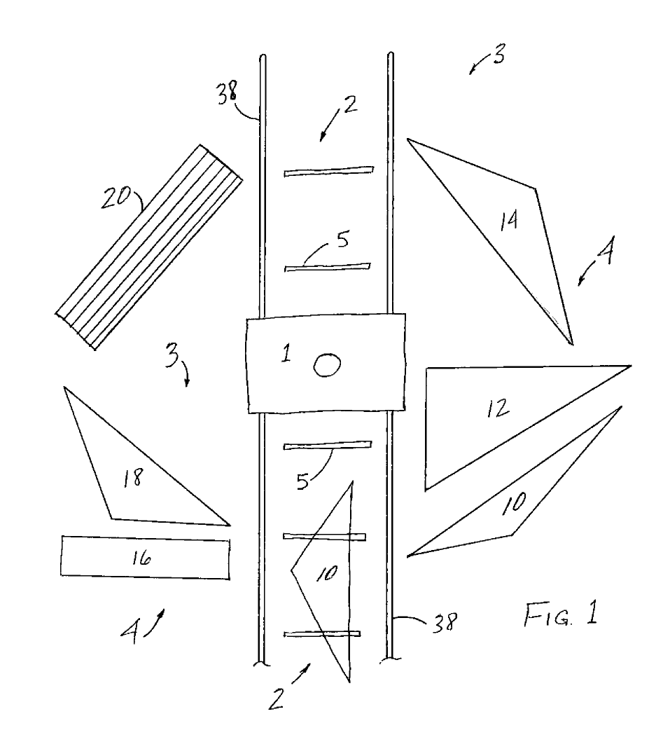

In plan view, FIG. 1 shows a schematic diagram of the manner in which a variety of differing trusses 10-20 may be stacked in a staging area 3, typically on the floor or ground space about a conveyor system 2. Trusses 10-20 are typically assembled on a truss assembly table, not shown. The apparatus 1 may be employed to lift trusses directly from the truss assembly table, although the trusses are typically removed from the truss assembly table, either by hand or automatically, for further processing, such as by a roller press. Once the trusses are complete, they are typically moved by a conveyor system 2 towards a staging area 3. Typically, a conveyor system 2 extends through most or all of the length of the staging area 3. The conveyor system 2 often consists of a series of roll conveyors 5, although belt, chain and other types of conveyors may be used. The conveyor system 2 is preferably powered, for example, with alternating powered and dummy roll conveyors 5.

The truss handling apparatus 1, is utilized to lift trusses 10-20 from the conveyor system 2, and align and stack the trusses in stacks 4. The truss handling apparatus 1 preferably includes a boom or knuckleboom crane 22 capable of rotating about a deck 24. The truss handler 1 is designed to allow creation of multiple stacks 4 of trusses. Preferably, the truss handling apparatus 1 is capable of creating stacks oriented horizontally, as shown with trusses 10-18, vertically, as shown with trusses 20, and in any other selected orientation. Both floor trusses, such as trusses 16, and roof trusses may be handled, as desired. The use of vertically oriented stacks allows for more efficient use of staging area space, which may be desired where space is at a premium.

The truss handling apparatus 1 can be stationary or mobile. Where the truss handler 1 is stationary, the stacks may be arranged in a generally circular pattern around the handler. A mobile truss handler allows for greater flexibility in arrangement and number of truss stacks 4, and allows stacking in a larger staging area 3. Additionally, the apparatus 1 allows for rotation of the trusses with respect to the crane deck. Consequently, the trusses may be rotated from their orientation on the conveyor system 2, re-oriented as desired, and then stacked, allowing for a greater number of stacks in a smaller area. The stacks can be formed beside and at angles to the roller conveyor system 2. Preferably, the truss handling apparatus 1 is mobile. Shown in FIG. 1 is a mobile handling apparatus 1, which is wheeled and mounted to run on tracks or rails 38. Where the truss handler 1 is mobile, as shown, it can lift trusses from anywhere along the length of the conveyor system 2.

The trusses 10-20 may be of varying types and sizes. Especially with today's design complexity, the completed trusses, even for use on a single structure, may vary substantially in size and shape. This presents problems for stacking of trusses in the staging area 3. When multiple trusses of the same or similar size and shape are employed on a structure, stacking of the trusses is simplified as the trusses can easily be aligned and stacked atop one another, with the lower trusses providing adequate support across the span of overlying trusses. With varying sizes and shapes of trusses, however, the underlying trusses may not provide adequate support across the span of overlying trusses. Consequently, there is a need for a greater number of stacks, so that trusses can be better segregated by size and shape or aligned to provide adequate support for transport. FIG. 1 presents a plan view, wherein several stacks of trusses are employed to handle trusses of differing shape and size. As those skilled in the art will recognize, where trusses of varying shape and size are stacked in a single stack, the trusses may require shoring-up to prevent overlying trusses from bending (or bouncing) during transport. Typically, this shoring up is done with short two-by-fours placed between stacked trusses. It is to be understood that the stacking arrangement shown is not represented as an optimum arrangement but is only intended to show the operational flexibilities of the present inventions.

Additionally, since it is now more common for a variety of truss shapes and sizes to be utilized in a single structure, greater flexibility is needed in aligning the trusses for stacking. That is, a single stack may have trusses of varying size and shape, such that the truss members (chords and webs) are not coextensive. For example, where a roof structure has multiple trusses of identical specifications, the chords and webs of the trusses align, supporting overlying trusses in a stack, by simply stacking the trusses in a common orientation. Using prior art materials handlers, identical trusses, indexed to common posts, will stack in an aligned orientation. This is not necessarily true, however, for a variety of truss shapes.

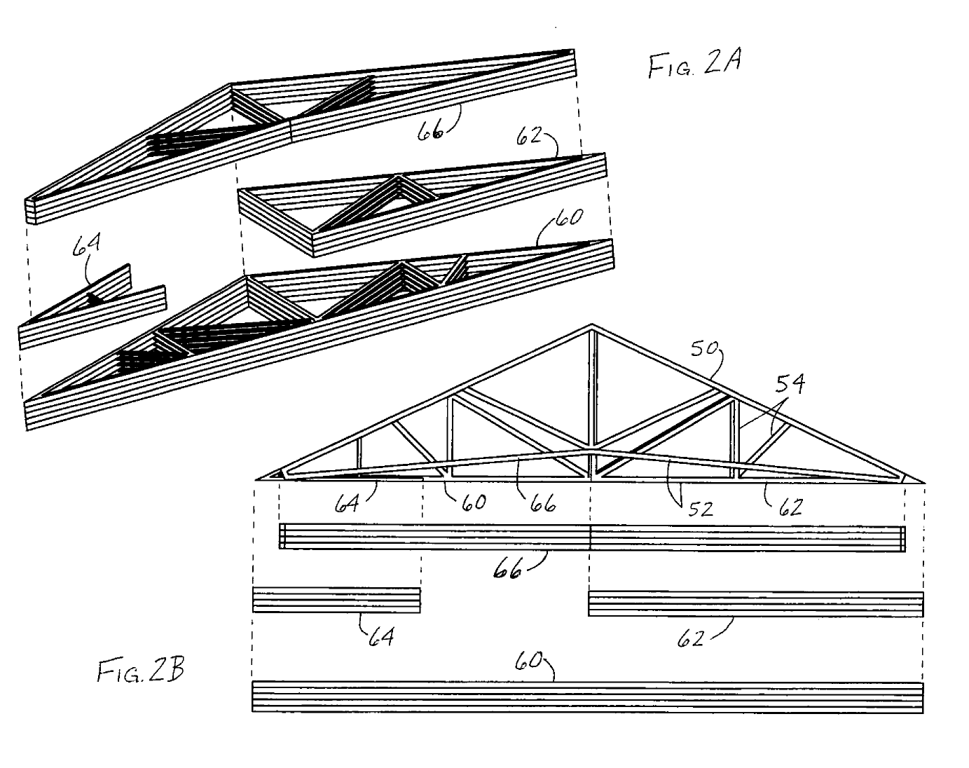

The truss handling apparatus 1 preferably allows for flexibility in stacking alignment. The user can operate the truss handling apparatus to selectively align portions of a truss with portions of underlying trusses. This process, referred to herein as “aligning” trusses, is often an inexact science. The user, through experience, will recognize how to efficiently stack trusses such that the individual members of the trusses are coextensive to a degree to provide support for the trusses. In FIG. 2, various shapes and sizes of trusses are stacked, with selected portions of the trusses coextensive. This is merely a sample arrangement. FIG. 2A is an exploded view showing multiple trusses of four varying truss designs aligned in a stack. FIG. 2B shows the same stack from a top view and front elevation view. Utilizing a preferred embodiment of the truss handler 1, the user may selectively align top chords 50, bottom chords 52, and webs 54 to provide support for the overlying trusses. Here, the top chords 50 of the tri-bearing trusses 60 on the bottom of the stack 4 are aligned with the top chord of the mono trusses 62 in the middle of the stack and the top chords of the scissor trusses 66 at the top of the stack. Additionally, the two chords of the jack rafters 64 are aligned with the top 50 and bottom 52 chords of the tri-bearing 60 and scissor 66 trusses. Were the trusses indexed along the bottom chord, as in some prior art stackers for example, the top chords of the scissor and tri-bearing trusses would not align.

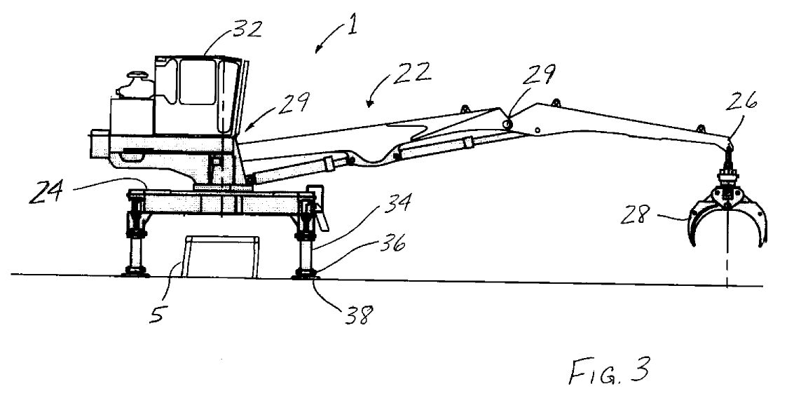

FIG. 3 shows an elevation view of truss handling apparatus 1 having a knuckle boom crane 22 mounted for rotation on base or deck 24. The boom crane 22 may be replaced with other types of crane without departing from the spirit of the invention. Cranes are commercially available from John Deere™, Prentice™, and Caterpillar™, among others. The crane 22 must be capable of engaging a truss, lifting it, moving it to the selected stack, and lowering the truss onto the stack. Preferably, an extendable crane 22 is utilized, as shown. The crane 22 is shown in an extended position, and can be retracted. This allows for the user to place the trusses 10-20 in stacks 4 over a wider area. Alternate types of crane can employ telescoping arms, more or fewer joints 29, etc. The apparatus 1 may have a cab 32, with operational controls for the user to operate the crane 22 and engaging assembly 28. The crane 22 is mounted for rotation on deck 24, preferably for 360 degrees of rotation.

Mounted to the working end 26 of the boom crane 22 is truss engaging assembly 28. Truss engaging assembly 28 is configured for picking up trusses 10, which are typically in a horizontal orientation on a conveyor system. The engaging assembly 28 can take a variety of configurations, as will be recognized by those of skill in the art. An exemplary truss engaging assembly is illustrated and explained herein. The engaging assembly must be capable of grappling or otherwise engaging a truss, allowing the truss to be supported when the crane 22 moves or lifts the truss. The truss engaging assembly must provide support ample to maintain the integrity of the truss during movement and stacking. Further, the truss engaging assembly must not, during grappling of the truss, place undue stresses on the truss, thereby damaging it.

The truss handling apparatus can be stationary or mobile. In FIG. 3, a mobile truss handling apparatus 1 is placed, in a preferred arrangement, straddling or bridging the conveyor system 2. The crane 22 and deck 24 are mounted on a frame 34 of the apparatus 1. The frame 34 extends across and above the roller conveyors 5 of conveyor system 2. The frame 34 includes wheels 36 which ride upon tracks 38 which run parallel to the conveyor system 2. Alternately, the apparatus can move on wheels, treads, or other suitable means. A typical system is 50-75 feet long, but can be as much as 200-300 feet or longer.

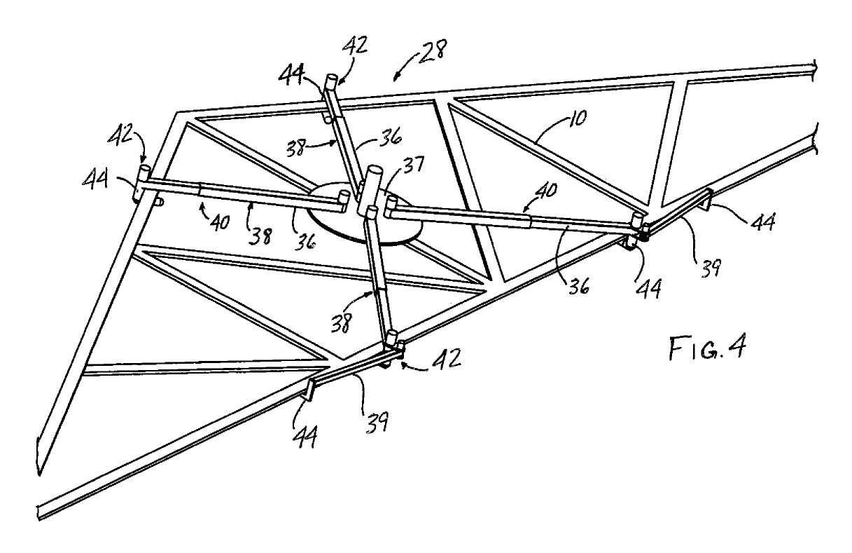

One embodiment of a truss engaging assembly 28 is shown in detail in FIG. 4. The invention is not limited to the particular embodiment shown herein. Those of skill in the art will recognize that various other arrangements may be designed and utilized to engage completed trusses. The illustrated embodiment of the truss engagement assembly incorporates multiple engagement arms 38 mounted on an base plate 37. The base plate 37 rotates about an axis perpendicular to the plate, such that trusses can be rotated or turned after they are lifted. This allows selective alignment of the trusses in the stacks.

Preferably, the engagement arms 38 incorporates four primary arms 36, although more or fewer may be utilized. The primary arms 36 pivot with respect to base plate 37 allowing the arms 36 to “scissor” together. The arms 36 are operated by preferably independently controllable, each having actuators, such as rotary motors and the like. Further, since the truss 10 may vary in size from a few feet in length to 80 feet or more, the arms 36 preferably telescope to variable lengths along telescoping assemblies 40. The telescoping assemblies are also preferably independently controllable. The scissoring and telescoping capacities of the arms 36 allow the engagement assembly to selectively engage the truss 10 at various points along the truss. Folding, jointed, accordion or other arm assemblies may alternately be used.

Optionally, the engagement arms 38 can include extension segments 39 which are attached to and extend from arms 38. Segments 39 pivot with respect to primary arms 36 and provide further reach for the engagement assembly 28. The pivoting extension segments 39 can be used alone or in conjunction with the telescoping assemblies of the primary arms 36. The pivoting extension segment is driven by an independently controlled actuator, such as a rotary motor or other device.

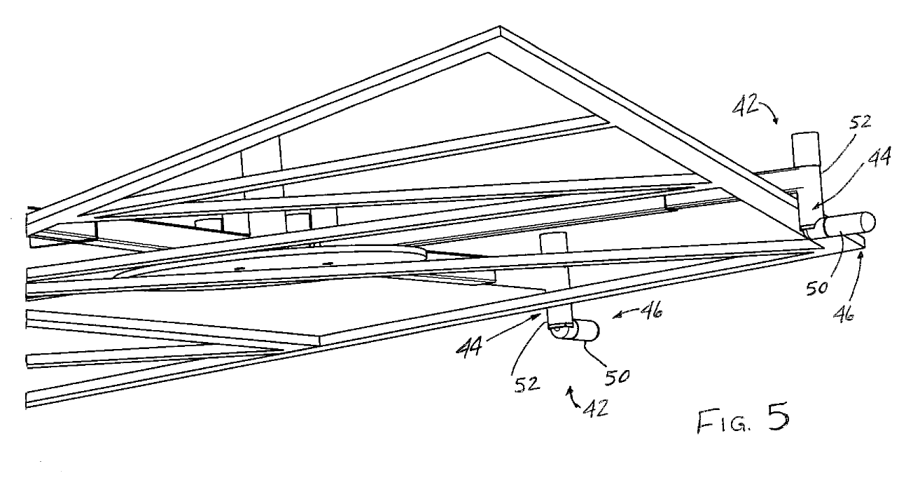

The engaging assembly 28 includes a contacting assembly 42. At the ends of each primary arm 36 is preferably mounted a hook or grappling device 44. The particular design of the hook 44 may vary without departing from the spirit of the invention. The hooks 44 are designed to contact the truss during lifting and are preferably designed to move under the truss 10 as it sits on the conveyor 2 or other surface. A preferred embodiment of the hooks 44 is seen in FIG. 5. In a preferred embodiment, the hooks 44 are L-shaped, although other shapes can be utilized. Hooks 44 are mounted at the ends of the primary arms 38 and extension segments 39.

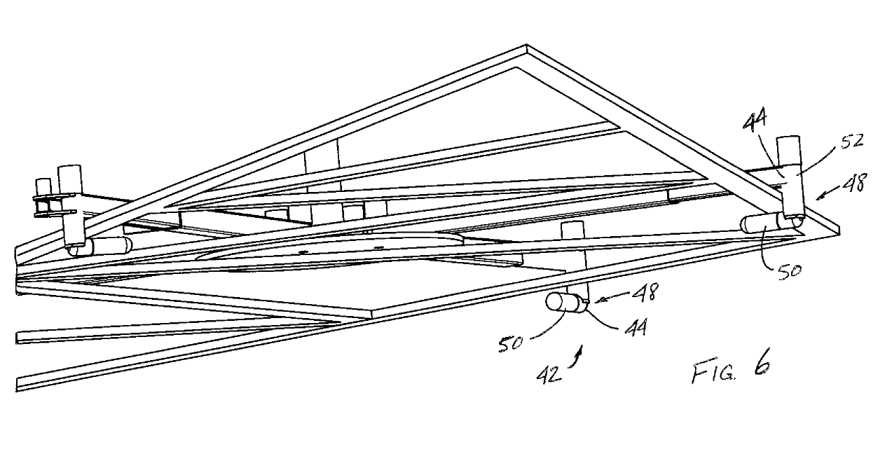

In a preferred embodiment, the hooks are mounted for movement between an open position 46, seen in FIG. 5, and a closed position 48, seen in FIG. 6. Here, the hooks 44 are mounted for rotary movement such that, when in the closed position 48, a lower portion 50 of the hook 44 is under the truss, contacting the truss during lifting, rotation and other movement of the truss. In the open position 46, the lower portion 50 of the hook 44 does not engage the truss. The hooks 44 are not required to be movable with respect to the arms 38 in all embodiments. For example, in FIG. 4, the hooks 44 at the ends of the extension segments 39 are not independently movable. Movable hooks can pivot, rotate, fold or otherwise move between the open and closed positions. Movable hooks, such as rotary hooks 44, are preferably driven by independently operable actuators.

The upper portion 52 of the hook 44 can contact the truss 10, although undue “clamping” of the truss is not preferred. Although the contacting assembly 42 can be used to “clamp” the truss, holding it during lifting and movement, it is preferred that the contacting assembly 42 not be utilized in such a fashion to reduce the likelihood of damage to the truss 10. If the contacting assembly is clamped onto the truss, a concentrated load is placed on the truss at the points of contact. Such forces may cause damage to the truss. Consequently, it is preferable that the hooks 44 be used to contact the truss 10 for weight-bearing support, lifting the truss from below. When the truss 10 is in a horizontal orientation, as in FIGS. 4-6, the lower portion 50 of the hook will contact the truss, bearing the weight of the truss. If the truss 10 is tilted to an upright orientation, the truss weight will be supported by contact with the upper portions 52 of the hooks 44. The upper portions 52 of the hooks 44 can be moved into contact with a truss 10 as it lies horizontally on a conveyor 2 for indexing purposes, that is, so the user knows the engagement arms and hooks are in position. However, as discussed above, the upper portions 52 of the hook should not be clamped onto the truss with undue force.

Other embodiments of the truss engagement assembly can be employed. For example, the truss engagement assembly may utilize clamps which engage the top and bottom faces of the truss. Alternately, the engagement assembly may utilize a hook or hooks of various design which hook under members of the truss. Those skilled in the art will recognize other arrangements without departing from the spirit of the invention.

Finally, the truss engagement assembly 28 is preferably mounted to the working end 26 of the crane 22 such that the engagement assembly 28 can tilt with respect to the crane, or with respect to the ground. That is, the mounting to the crane 22 allows the engagement assembly to tilt a truss 10 into a vertical orientation for stacking. Such a degree of movement allows stacking of trusses in vertical, horizontal or any other orientation. The preferred “wrist joint” mounting of the engagement assembly to the crane allows for great freedom in stacking arrangements. Although not all of these modes of movement are required, they are preferred.

In use, the user can operate the truss handling apparatus 1 from within cab 32 or other operating position. The user has appropriate controllers to extend and retract the boom crane, raise and lower the crane, rotate the crane about its base, rotate and tilt the engagement assembly, pivot and telescope the primary arms of the engagement assembly, and pivot the hooks of the contacting assembly. Where a mobile apparatus 1 is utilized, the user also controls movement of the truss handling apparatus. All of these movements may be accomplished using electronic, mechanical or hydraulic controls to operate motors, hydraulics, etc., to move the elements of the apparatus.

During use, the truss handling apparatus 1 is moved along the tracks 38 to any selected position. The crane 22 is rotated on deck 24 and extended into position above a truss 10 to be moved. The crane is then extended and lowered into proximity with the truss 10. The engagement assembly is moved into an appropriate position for engaging the truss, most probably substantially horizontal to the ground. The primary arms 36, and extension segments are pivoted and telescoped into position. The hooks 44 are moved to a closed position, or, if not movable, aligned below portions of the truss. The truss is then lifted by the crane and moved over a selected stack of trusses. The engagement assembly is rotated or tilted as desired to align the truss in a stack. The truss is then lowered or placed in the stack. The hooks are then moved to the open position, releasing the truss onto the stack.

The hooks 44 are preferably designed to provide a “clean” release of the truss onto a stack. When placing a truss 10 in a horizontally oriented stack, for example, the truss can be positioned and aligned directly above the stack. However, the hooks 44 will likely interfere with and prevent lowering the truss all the way onto the stack. With the truss in position, the hooks are moved to the open position and the truss drops, at least the diameter or width of the lower hook portion, onto the stack. The upper portion 52 of the hooks 44 are preferably substantially perpendicular to the lower portion 50 of the hook, such that the upper portion does not interfere with the truss as it is released onto the stack.

The trusses may be rotated and tilted as desired to place the trusses in various orientations and alignments. The process is repeated as necessary.

The embodiments shown and described above are exemplary. It is not claimed that all of the details, parts, elements, or steps described and shown were invented herein. Even though many characteristics and advantages of the present inventions have been described in the drawings and accompanying text, the description is illustrative only. Changes may be made in the detail, especially in matters of shape, size, and arrangement of the parts within the scope and principles of the inventions. The restrictive description and drawings of the specific examples above do not point out what an infringement of this patent would be, but are to provide at least one explanation of how to use and make the inventions. The limits of the inventions and the bounds of the patent protection are measured by and defined in the following claims.

What is claimed is:

1. An truss handling apparatus for arranging completed trusses in multiple stacks in a staging area, the apparatus comprising:
a deck supporting an extendable crane, the crane mounted for rotational movement in relation to the deck, the crane having a working end, the working end able to move vertically with respect to the deck;
a truss engaging assembly attached to the end of the extendable crane, the truss engaging assembly able to engage a truss, the crane able to lift the truss while the truss engaging assembly engages the truss;
the truss engaging assembly able to rotate with respect to the end of the crane;
the truss handling apparatus able to lift a truss, move the truss and stack the truss in one of multiple stacks in a staging area.

2. An apparatus as in claim 1, the staging area having multiple stacks of trusses.

3. An apparatus as in claim 1, the truss engaging assembly able to tilt with respect to the end of the crane.

4. An apparatus as in claim 2, the apparatus able to place a truss in a substantially vertical stack.

5. An apparatus as in claim 1, wherein the boom crane is mounted for 360 degree rotation.

6. An apparatus as in claim 1, further comprising a frame, the deck mounted on the frame, the frame having wheels for movement with respect to the ground.

7. An apparatus as in claim 1, wherein the truss engaging assembly is able to rotate a truss.

8. An apparatus as in claim 7 wherein the truss engaging assembly is able to rotate a truss 360 degrees.

9. An apparatus as in claim 7, wherein the truss engaging assembly is able to tilt a truss.

10. As in claim 1, wherein the truss engaging assembly is able to tilt a truss.

11. As in claim 1, wherein the truss engaging assembly further comprises movable arms.

12. An apparatus as in claim 11, wherein the movable arms are telescoping arms.

13. An apparatus as in claim 1, wherein the truss engaging assembly further comprises pivoting arms.

14. An apparatus as in claim 1, the truss engaging assembly having at least one hook for engaging the truss.

15. An apparatus as in claim 1, wherein the truss engaging assembly further comprises at least one truss contacting assembly, the truss contacting assembly comprising a movable member able to move under the truss for supporting the truss when it is lifted.

16. An apparatus as in claim 15, wherein the truss contacting assembly comprises a rotatable hook.

17. A method for handling completed trusses, the method comprising the steps of:
engaging a completed truss;
lifting the completed truss;
rotating the completed truss;
moving the completed truss to a staging area having multiple stacks of trusses;
aligning the truss with respect to a selected stack of trusses; and
placing the truss in one of the multiple stacks of trusses in the staging area.

18. A method as in claim 17, further comprising the step of tilting the completed truss.

19. A method as in claim 17, wherein the truss, when engaged, is supported from below.

20. A method as in claim 17, further comprising placing the truss in a stack in an upright orientation.
